(19) United States
(12) Patent Application Publication
(10) Pub. No.: US 2026/0171792 A1
(43) Pub. Date: Jun. 18, 2026

(54) SEMICONDUCTOR DEVICE

(71) Applicant: Kioxia Corporation, Tokyo (JP)

(72) Inventors: Kentaro WATANABE, Yokohama (JP); Masato DOME, Kamakura (JP); Yutaka SHIMIZU, Yokohama (JP); Shigefumi ISHIGURO, Chigasaki (JP)

(73) Assignee: Kioxia Corporation, Tokyo (JP)

(21) Appl. No.: 19/317,487

(22) Filed: Sep. 3, 2025

(30) Foreign Application Priority Data
Dec. 18, 2024 (JP) 2024-221683

(51) Int. Cl. H02H 9/04; H02H 9/00

(52) U.S. Cl. CPC H02H 9/046; H02H 9/005

(57) ABSTRACT

A semiconductor device includes a first line having a first potential, a second line having a second potential lower than the first potential, a third line having a third potential lower than the second potential, a series circuit of a first and a second transistors connected between the second and the third lines, an input/output terminal connected to a node of the first and the second transistors, a first prebuffer having an output terminal connected to a control electrode of the first transistor, a second prebuffer having an output terminal connected to a control electrode of the second transistor, and a protection circuit configured to control a potential of the control electrode of at least one of the first and the second transistors to be not less than the third potential and not greater than the potential of the second line when a discharge from the input/output terminal is detected.

### CROSS-REFERENCE TO RELATED APPLICATION

This application is based upon and claims the benefit of priority from Japanese Patent Application No. 2024-221683, filed December 18, 2024; the entire contents of which are incorporated herein by reference.

### FIELD

Embodiments described herein relate generally to a semiconductor device.

### BACKGROUND

In a semiconductor device such as a semiconductor integrated circuit, the semiconductor device is known to have a protection circuit for protecting internal circuits from a surge generated by electrostatic discharge (ESD) and other discharges from a power terminal, an input/output terminal, and the like.

### BRIEF DESCRIPTION OF THE DRAWINGS

FIG. 1 is a circuit diagram illustrating a partial configuration of a semiconductor device according to a reference example.

FIG. 2 is a circuit diagram illustrating a partial configuration of a semiconductor device according to a first embodiment.

FIG. 3 is a circuit diagram illustrating a partial configuration of a semiconductor device according to a second embodiment.

FIG. 4 is a circuit diagram illustrating a partial configuration of a semiconductor device according to a third embodiment.

FIG. 5 is a circuit diagram illustrating a partial configuration of a semiconductor device according to a fourth embodiment.

FIG. 6 is a circuit diagram illustrating a partial configuration of a semiconductor device according to a fifth embodiment.

FIG. 7 is a circuit diagram illustrating a partial configuration of a semiconductor device according to a sixth embodiment.

FIG. 8 is a circuit diagram illustrating a partial configuration of a semiconductor device according to a seventh embodiment.

### DETAILED DESCRIPTION

Embodiments will be described with reference to the drawings. In the description of the drawings described below, the same or similar parts are denoted by the same or similar reference numerals. The drawings are schematic. In addition, the following embodiments illustrate devices and methods for realizing technical ideas, and do not specify the material, shape, structure, arrangement, and the like of components. Various changes may be made to the embodiments.

### Reference Example

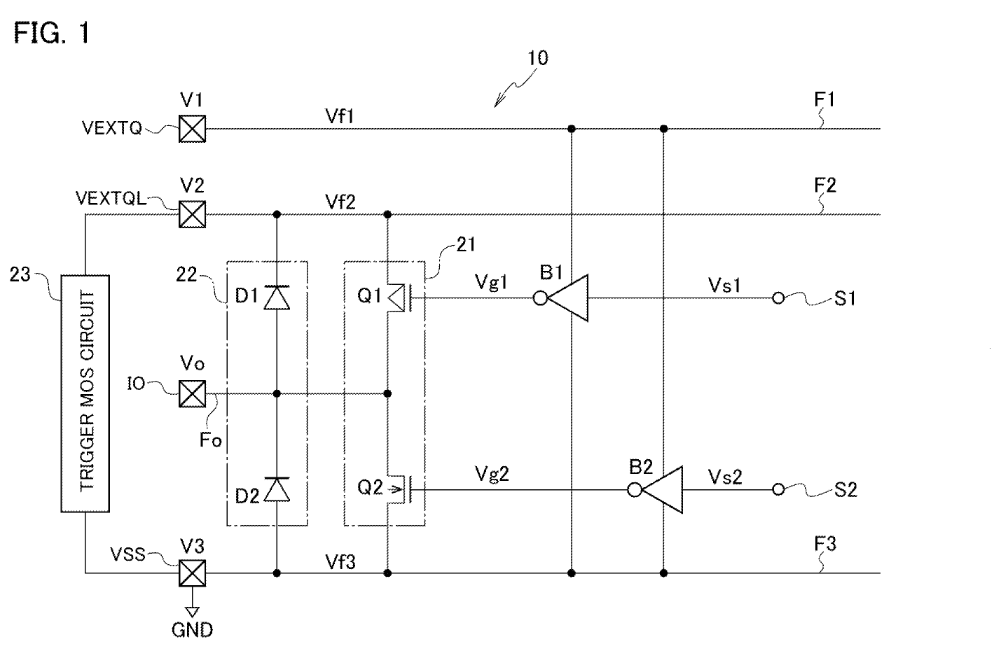

With reference to FIG. 1, a semiconductor device 10 according to a reference example will be described before describing semiconductor devices according to embodiments. FIG. 1 is a circuit diagram illustrating a partial configuration of an output circuit of the semiconductor device 10 according to the reference example. The semiconductor device 10 is, for example, a semiconductor memory such as a NAND flash memory or a Dynamic Random Access Memory (DRAM).

As illustrated in FIG. 1, the semiconductor device 10 includes a first power supply terminal VEXTQ, a second power supply terminal VEXTQL, a third power supply terminal VSS, and an input/output terminal IO. The first power supply terminal VEXTQ is connected to a first line F1 inside the semiconductor device 10. The first power supply terminal VEXTQ is connected to a first external power supply (not illustrated) having a first potential V1. A first line potential Vf1, which is the potential of the first line F1, becomes the first potential V1. The second power supply terminal VEXTQL is connected to a second line F2 inside the semiconductor device 10. The second power supply terminal VEXTQL is connected to a second external power supply (not illustrated) having a second potential V2 lower than the first potential V1. A second line potential Vf2, which is the potential of the second line F2, becomes the second potential V2. The third power supply terminal VSS is connected to a third line F3 inside the semiconductor device 10. The third power supply terminal VSS is connected to third potential V3 (for example, ground GND at 0 V), which is an external reference potential lower than the second potential V2. The third line potential Vf3, which is the potential of the third line F3, becomes the third potential V3. The input/output terminal IO is shared with an input circuit (not illustrated).

The semiconductor device 10 is a two-power supply semiconductor device supplied with the first potential V1 and the second potential V2. The first potential V1 is, for example, 1.2 V or 1.8 V. The second potential V2 is, for example, 0.6 V or 0.6 to 1.2 V. The third potential V3 is, for example, 0 V.

A switch circuit 21 serving as an off-chip driver (OCD) / on-die termination (ODT) is connected between the second line F2 and the third line F3. The switch circuit 21 is a series circuit of a first transistor Q1 on a high side and a second transistor Q2 on a low side. The first transistor Q1 is configured as a P-channel MOSFET. The second transistor Q2 is configured as an N-channel MOSFET. A first main electrode (source) of the first transistor Q1 is connected to the second line F2. A second main electrode (drain) of the first transistor Q1 is connected to a second main electrode (drain) of the second transistor Q2. A first main electrode (source) of the second transistor Q2 is connected to the third line F3. A connection point of the first transistor Q1 and the second transistor Q2 is connected to the input/output terminal IO through an output line Fo. The second line potential Vf2, which is the second potential V2, is supplied to the switch circuit 21 as a dedicated power supply. Here, "a connection point between A and B" can be a portion included in a conductive component that electrically connects A and B. For example, it can be a portion on a wiring that connects A and B, a terminal provided on A, or a terminal provided on B.

A first diode D1 is connected in parallel to the first transistor Q1. A cathode of the first diode D1 is connected to the first main electrode of the first transistor Q1, and an anode of the first diode D1 is connected to the second main electrode of the first transistor Q1. The first diode D1 may be a parasitic diode of the first transistor Q1. A second diode D2 is connected in parallel to the second transistor Q2. A cathode of the second diode D2 is connected to the second main electrode of the second transistor Q2, and an anode of the second diode D2 is connected to the first main electrode of the second transistor Q2. The second diode D2 may be a parasitic diode of the second transistor Q2. The series circuit 22 of the first diode D1 and the second diode D2 function as protection diodes for protecting internal circuits of the semiconductor device 10 from a surge generated by a discharge, such as ElectroStatic Discharge (ESD), from the input/output terminal IO.

A control electrode (gate) of the first transistor Q1 is connected to an output terminal of a first inverter B1 as a pre-buffer of the first transistor Q1. A control electrode (gate) of the second transistor Q2 is connected to an output terminal of a second inverter B2 as a pre-buffer of the second transistor Q2. Positive power terminals of the first inverter B1 and the second inverter B2 are connected to the first line F1, and negative power terminals of the first inverter B1 and the second inverter B2 are connected to the third line F3. The first line potential Vf1, which is the first potential V1, is supplied to the first inverter B1 and the second inverter B2 as a power source. The first line potential Vf1 is also supplied as power sources to the internal circuits of the semiconductor device 10 other than the first inverter B1 and the second inverter B2.

An input terminal of the first inverter B1 is connected to a first internal terminal S1, and is a first internal signal Vs1 is applied therefrom. When the first internal signal Vs1 is at an H level, the first inverter B1 outputs the third potential V3, which is a signal at an L level, as a first gate signal Vg1. When the first gate signal Vg1 is at the L level, the first transistor Q1 is turned on (conductive). When the first internal signal Vs1 is at the L level, the first inverter B1 outputs the first potential V1, which is a signal at the H level, as the first gate signal Vg1. When the first gate signal Vg1 is at the H level, the first transistor Q1 is turned off (open).

The input terminal of the second inverter B2 is connected to a second internal terminal S2, and is a second internal signal Vs2 is applied therefrom. When the second internal signal Vs2 is at the H level, the second inverter B2 outputs the third potential V3, which is a signal at the L level, as the second gate signal Vg2. When the second gate signal Vg2 is at the L level, the second transistor Q2 is turned off (open). When the second internal signal Vs2 is at the L level, the second inverter B2 outputs the first potential V1, which is a signal at the H level, as the second gate signal Vg2. When the second gate signal Vg2 is at the H level, the second transistor Q2 is turned on (conductive).

When the first internal signal Vs1 and the second internal signal Vs2 are at the H level, the first transistor Q1 is turned on and the second transistor Q2 is turned off, so that the second potential V2 is output to the input/output terminal IO as the output signal Vo, which is a signal at the H level. When the first internal signal Vs1 and the second internal signal Vs2 are at the L level, the first transistor Q1 is turned off and the second transistor Q2 is turned on, so that the third potential V3 is output to the input/output terminal IO as the output signal Vo, which is a signal at the L level. When the first internal signal Vs1 is at the L level and the second internal signal Vs2 is at the H level, both the first transistor Q1 and the second transistor Q2 are turned off, so that the input/output terminal IO is in a high impedance (Hi-Z) state.

A trigger MOS circuit 23 is connected between the second power supply terminal VEXTQL and the third power supply terminal VSS as a protection circuit for protecting the internal circuits of the semiconductor device 10 from a surge generated by discharge of ESD or the like from the input/output terminal IO. The trigger MOS circuit 23 of a known configuration can be used, and is not further described.

In the semiconductor device 10 with two-power supplies described above, when a surge is generated by discharge of ESD or the like from the input/output terminal IO, the potential of the input/output terminal IO rises to a potential higher than the second potential V2. Then, an electric current flowing through the path in the order of the input/output terminal IO, the first diode D1, the trigger MOS circuit 23, the third power supply terminal VSS, and the ground GND is generated.

Then, due to the influence of the current caused by the surge, the second line potential Vf2 rises above the second potential V2. However, when a surge such as ESD is generated from the input/output terminal IO, the first potential V1 may not be applied to the first power supply terminal VEXTQ. Then, the first line potential Vf1 becomes lower than the second line potential Vf2 and, in some cases, lower than the third line potential Vf3. Then, the potential of the first gate signal Vg1 and the second gate signal Vg2 also become lower. The drain potential of the first transistor Q1 and the second transistor Q2 rise together with the potential of the input/output terminal IO, thereby causing the risk of overvoltage breakdown due to the rise of the drain gate voltage of the first transistor Q1 and the drain gate voltage of the second transistor Q2 increasing.

In comparison with the semiconductor device 10 according to the reference example, the embodiments below describe a semiconductor device including a protection circuit that can reduce potential fluctuation generated in the internal circuits even when a surge occurs due to discharge of ESD or the like from the input/output terminal IO.

### First Embodiment

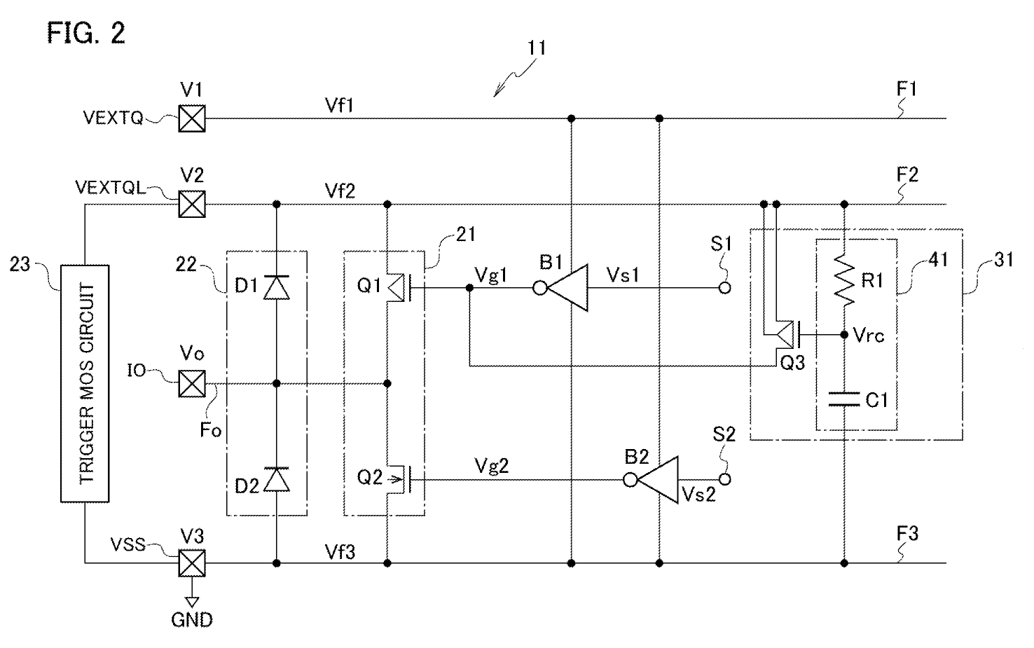

With reference to FIG. 2, a semiconductor device 11 according to a first embodiment will be described. FIG. 2 is a circuit diagram illustrating a partial configuration of the semiconductor device 11 according to the first embodiment. The semiconductor device 11 according to the first embodiment is configured by adding a protection circuit 31 to the semiconductor device 10 according to the reference example.

The protection circuit 31 includes an RC circuit 41 and a third transistor Q3. The RC circuit 41 is a series circuit of a resistor R1 and a capacitor C1. A first end of the resistor R1 is connected to the second line F2, a second end of the resistor R1 is connected to the first end of the capacitor C1, and the second end of the capacitor C1 is connected to the third line F3. The third transistor Q3 is a semiconductor switch and configured as a P-channel MOSFET. In the third transistor Q3, a source and a body are connected to the second line F2; a drain is connected to a connection point between a gate of the first transistor Q1 and an output terminal of the first inverter B1; and a gate is connected to a connection point between the resistor R1 and the capacitor C1.

The protection circuit 31 does not operate and does not affect the operation of the semiconductor device 11 during normal operation when a discharge such as ESD does not occur at the input/output terminal IO. That is, a potential Vrc at the connection point between the resistor R1 and the capacitor C1 is at the H level of the second potential V2, and the gate signal of the third transistor Q3 is at the H level, so that the third transistor Q3 is turned off. Therefore, when the first internal signal Vs1 is at the L level, the first gate signal Vg1 is at the H level of the first potential V1, and when the first internal signal Vs1 is at the H level, the first gate signal Vg1 is at the L level of the third potential V3.

However, when a discharge such as ESD occurs at the input/output terminal IO, the second line potential Vf2 rises. At this point, the RC circuit 41 of the protection circuit 31 detects a surge caused by the discharge and acts as follows. In the RC circuit 41, the propagation of the raised second line potential Vf2 to the potential Vrc at the connection point between the resistor R1 and the capacitor C1 is delayed, and the potential Vrc at the connection point maintains the potential before the discharge occurs. That is, in the third transistor Q3, the second line potential Vf2 applied to the source and body rises, and the potential of the gate signal is maintained. With reference to the potential of the source of the third transistor Q3, the gate signal is switched from the H level to the L level, and the third transistor Q3 is switched from off to on. Then, the first gate signal Vg1 is fixed at the second potential V2 to reduce fluctuations regardless of whether the first internal signal Vs1 is at the H level or the L level,

When a predetermined period of time elapses since the discharge, the potential Vrc at the connection point rises to the second line potential Vf2, and the gate signal of the third transistor Q3 is switched from the L level to the H level, so that the third transistor Q3 is switched from on to off and returns to the state of normal operation.

Thus, when a discharge such as ESD occurs at the input/output terminal IO, the protection circuit 31 fixes the first gate signal Vg1 at the second line potential Vf2 to reduce fluctuations. Therefore, it is possible to reduce fluctuations of the first gate signal Vg1 even when a discharge such as ESD occurs in the input/output terminal IO. As a result, overvoltage breakdown of the first transistor Q1 due to fluctuations of the first gate signal Vg1 can be prevented.

Further, in the first embodiment, the third transistor Q3 is configured as a P-channel MOSFET, and the first gate signal Vg1 is fixed at the H level of the second potential V2 to reduce fluctuations. For example, the third transistor Q3 is configured as an N-channel MOSFET, and the first gate signal Vg1 is fixed at the third potential V3 by inverting the connection between the second line F2 and the third line F3 of the RC circuit 41 to reduce fluctuations. With this configuration, it is also possible to reduce fluctuations of the first gate signal Vg1 to a potential lower than the third potential V3 even when a discharge such as ESD occurs in the input/output terminal IO. As a result, overvoltage breakdown of the first transistor Q1 due to fluctuations of the first gate signal Vg1 can be prevented.

### Second Embodiment

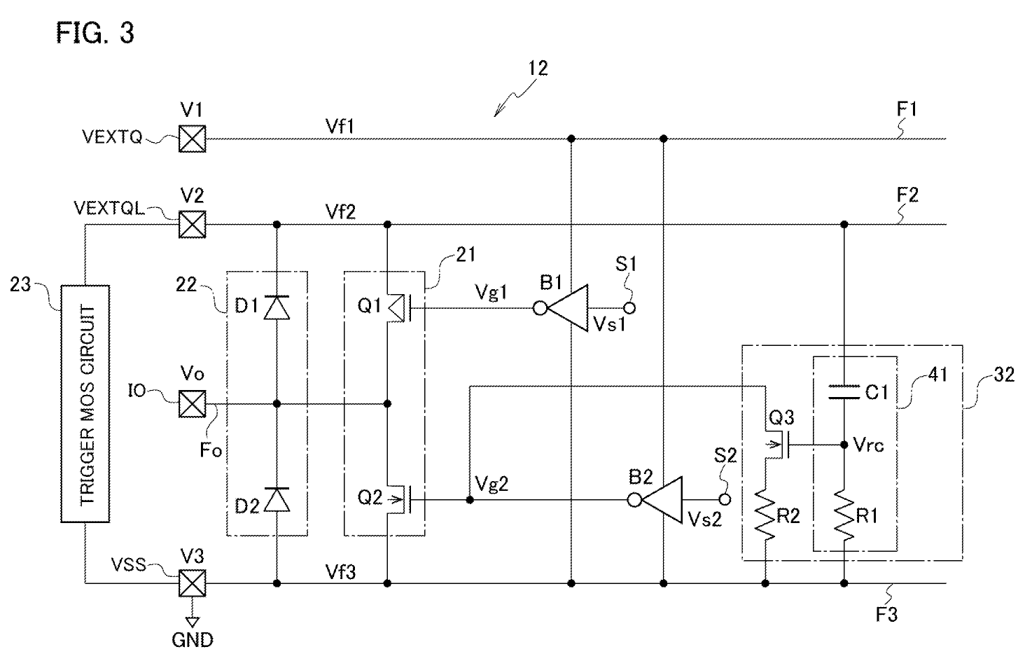

With reference to FIG. 3, a semiconductor device 12 according to a second embodiment will be described. FIG. 3 is a circuit diagram illustrating a partial configuration of the semiconductor device 12 according to the second embodiment. The semiconductor device 12 according to the second embodiment is configured by adding a protection circuit 32 to the semiconductor device 10 according to the reference example.

The protection circuit 32 includes the RC circuit 41 and the third transistor Q3. The RC circuit 41 is a series circuit of the capacitor C1 and the first resistor R1. The first end of the capacitor C1 is connected to the second line F2, the second end of the capacitor C1 is connected to the first end of the first resistor R1, and the second end of the first resistor R1 is connected to the third line F3. The protection circuit 32 further includes the second resistor R2. The third transistor Q3 is configured as an N-channel MOSFET. In the third transistor Q3, a drain is connected to a connection point between a gate of the second transistor Q2 and the second inverter B2; a source is connected to the third line F3 through the second resistor R2; and a gate is connected to a connection point between the capacitor C1 and the first resistor R1.

The protection circuit 32 does not operate and does not affect the operation of the semiconductor device 12 during normal operation when a discharge such as ESD does not occur at the input/output terminal IO. That is, the potential Vrc at the connection point between the capacitor C1 and the first resistor R1 is at the L level of the third potential V3, and the gate signal of the third transistor Q3 is at the L level, so that the third transistor Q3 is turned off. Therefore, when the second internal signal Vs2 is at the L level, the second gate signal Vg2 is at the H level of the first potential V1, and when the second internal signal Vs2 is at the H level, the second gate signal Vg2 is at the L level of the third potential V3.

However, when a discharge such as ESD occurs at the input/output terminal IO, the RC circuit 41 of the protection circuit 32 detects a surge caused by a discharge and acts as follows. In the RC circuit 41, the propagation of the third potential V3 to the potential Vrc at the connection point between the capacitor C1 and the first resistor R1 is delayed, and the potential Vrc at the connection point rises from the L level of the third potential V3 with the rise of the second line potential Vf2 due to the capacitance coupling of the capacitor C1. That is, the gate signal of the third transistor Q3 is switched from the L level to the H level, so that the third transistor Q3 is switched from off to on. Then, the second gate signal Vg2 is fixed at the third potential V3 regardless of whether the second internal signal Vs2 is at the H level or the L level.

When a predetermined period of time elapses after the discharge, the potential Vrc at the connection point drops to the third potential V3, and the gate signal of the third transistor Q3 is switched from the H level to the L level, so that the third transistor Q3 is switched from on to off and returns to the state of normal operation.

Thus, when a discharge such as ESD occurs at the input/output terminal IO, the protection circuit 32 fixes the second gate signal Vg2 at the third potential V3 to reduce fluctuations. Therefore, it is possible to reduce fluctuations of the second gate signal Vg2 to a potential lower than the third potential V3 even when a discharge such as ESD occurs at the input/output terminal IO. As a result, overvoltage breakdown of the second transistor Q2 due to fluctuations of the second gate signal Vg2 can be prevented.

Furthermore, if at least one of a displacement current and a gate leak current flows between the drain and gate of the second transistor Q2 when a discharge such as ESD occurs in the input/output terminal IO, these currents flow into the second resistor R2 and generate a potential in the second resistor R2. Therefore, the effect of raising the second gate signal Vg2 above the third potential V3 and reducing the second gate signal Vg2 to the third potential V3 or more, and the second line potential Vf2 or less, is expected when using at least one of the displacement current and the gate leak current flowing between the drain and gate of the second transistor Q2.

### Third Embodiment

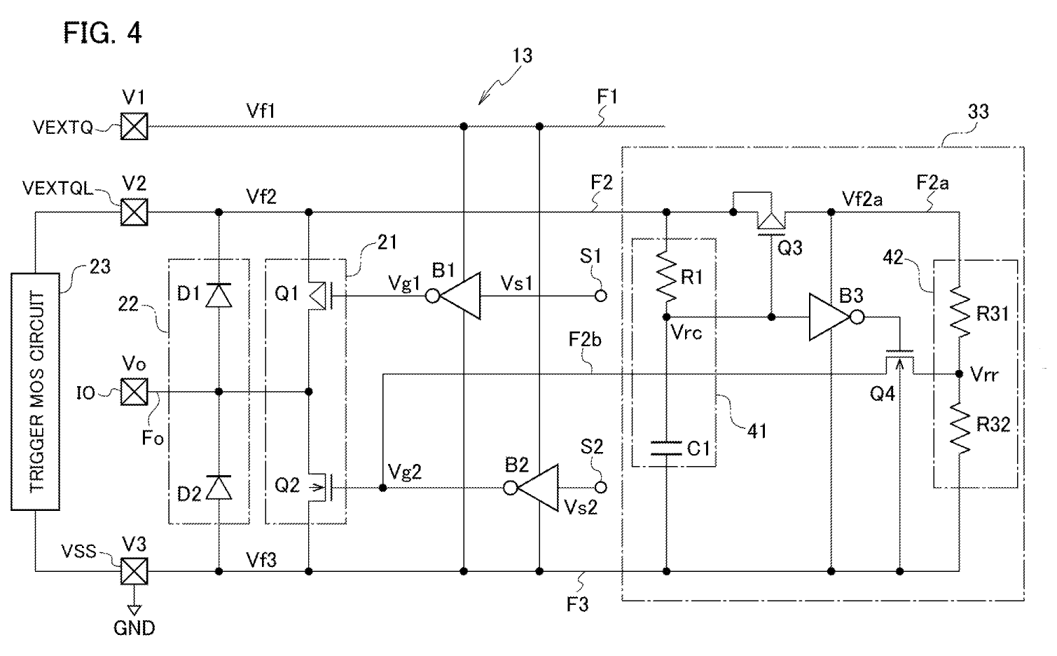

With reference to FIG. 4, a semiconductor device 13 according to a third embodiment will be described. FIG. 4 is a circuit diagram illustrating a partial configuration of the semiconductor device 13 according to the third embodiment. The semiconductor device 13 according to the third embodiment is configured by adding a protection circuit 33 to the semiconductor device 10 according to the reference example.

The protection circuit 33 includes the RC circuit 41, the third transistor Q3, a fourth transistor Q4, a third inverter B3, a voltage division circuit 42, a line F2a, and a line F2b. The RC circuit 41 is a series circuit of the resistor R1 and the capacitor C1. A first end of the resistor R1 is connected to the second line F2, a second end of resistor R1 is connected to a first end of capacitor C1, and the second end of capacitor C1 is connected to a third line F3. The third transistor Q3 is configured as a P-channel MOSFET. In the third transistor Q3, a source and a body are connected to second line F2, a drain is connected to line F2a, and a gate is connected to the connection point between resistor R1 and capacitor C1.

The voltage division circuit 42 is a series circuit of a first voltage divider resistor R31 and a second voltage divider resistor R32. A first end of the first voltage divider resistor R31 is connected to the line F2a, a second end of the first voltage divider resistor R31 is connected to the first end of the second voltage divider resistor R32, and the second end of the second voltage divider resistor R32 is connected to the third line F3.

In the third inverter B3, a positive power terminal is connected to the line F2a, and a negative power terminal connected to the third line F3, and an input terminal is connected to the connection point between resistor R1 and capacitor C1. The fourth transistor Q4 is configured as an N-channel MOSFET. In the fourth transistor Q4 a drain is connected to the connection point between the gate of second transistor Q2 and the output terminal of second inverter B2 through the line F2b, and a source is connected to the connection point between the first voltage divider resistor R31 and the second voltage divider resistor R32. In the fourth transistor Q4, a body is connected to the third line F3, and a gate is connected to an output terminal of the third inverter B3.

The protection circuit 33 does not operate and does not affect the operation of the semiconductor device 13 during normal operation when a discharge such as ESD does not occur at the input/output terminal IO. That is, the potential Vrc at the connection point between the resistor R1 and the capacitor C1 is at the H level of the second potential V2, and the gate signal of the third transistor Q3 is at the H level, so that the third transistor Q3 is turned off. Therefore, the line potential Vf2a, which is the potential of the line F2a, is equal to the third line potential Vf3 of the third line F3, that is, the third potential V3. The third inverter B3 does not operate because both the positive electrode terminal and the negative electrode terminal are at the third potential V3. The gate of the fourth transistor Q4 is at the L level of the third potential V3, so that the fourth transistor Q4 is turned off. Therefore, the second gate signal Vg2, which is also the potential of the line F2b, is at the H level of the first potential V1 when the second internal signal Vs2 is at the L level and is at the L level of the third potential V3 when the second internal signal Vs2 is at the H level.

However, when a discharge such as ESD occurs at the input/output terminal IO, the second line potential Vf2 applied to the source and body of the third transistor Q3 rises. At this point, the RC circuit 41 of the protection circuit 33 detects the surge caused by the discharge, and the potential Vrc at the connection point between the resistor R1 and the capacitor C1 is switched from the H level to the L level using the second line potential Vf2 as a reference, as described with reference to FIG. 2. That is, the gate signal of the third transistor Q3 is switched from the H level to the L level, and the third transistor Q3 is switched from off to on. Then, the line F2a and the second line F2 are connected, and the line potential Vf2a is switched from the third potential V3 to the second line potential Vf2. Then, in the third inverter B3, the second line potential Vf2 is supplied to the positive electrode terminal, and the L level is applied to the input terminal, so that the output terminal is at the H level of the second line potential Vf2, and the fourth transistor Q4 is switched from off to on.

A voltage division potential Vrr, which is a potential at the connection point between the first voltage divider resistor R31 and the second voltage divider resistor R32, is a value greater than or equal to the third potential V3, and less than or equal to the second potential V2, which is determined by the resistance values of the voltage divider resistor R31 and the second voltage divider resistor R32. Regardless of whether the second internal signal Vs2 is at the H level or the L level, the second gate signal Vg2 is fixed at the voltage division potential Vrr greater than or equal to the third potential V3, and less than or equal to the second line potential Vf2, which is determined by the resistance values of the first voltage divider resistor R31 and the second voltage divider resistor R32, to reduce fluctuations.

Thus, when a discharge such as ESD occurs at the input/output terminal IO, the protection circuit 33 fixes the second gate signal Vg2 at the voltage division potential Vrr regardless of whether the second internal signal Vs2 is at the H level or the L level, to reduce fluctuations. Therefore, it is possible to reduce fluctuations of the second gate signal Vg2 even when a discharge such as ESD occurs at the input/output terminal IO. As a result, overvoltage breakdown of the second transistor Q2 due to fluctuations of the second gate signal Vg2 can be prevented.

Furthermore, if at least one of the displacement current and the gate leak current flows between the drain and gate of the second transistor Q2 when a discharge such as ESD occurs at the input/output terminal IO, these currents flow into the second voltage divider resistor R32, thus causing the value of the voltage division potential Vrr to increase. Therefore, an effect to increase the value of the voltage division potential Vrr is expected by using at least one of the displacement current and the gate leak current between the drain and gate of the second transistor Q2.

### Fourth Embodiment

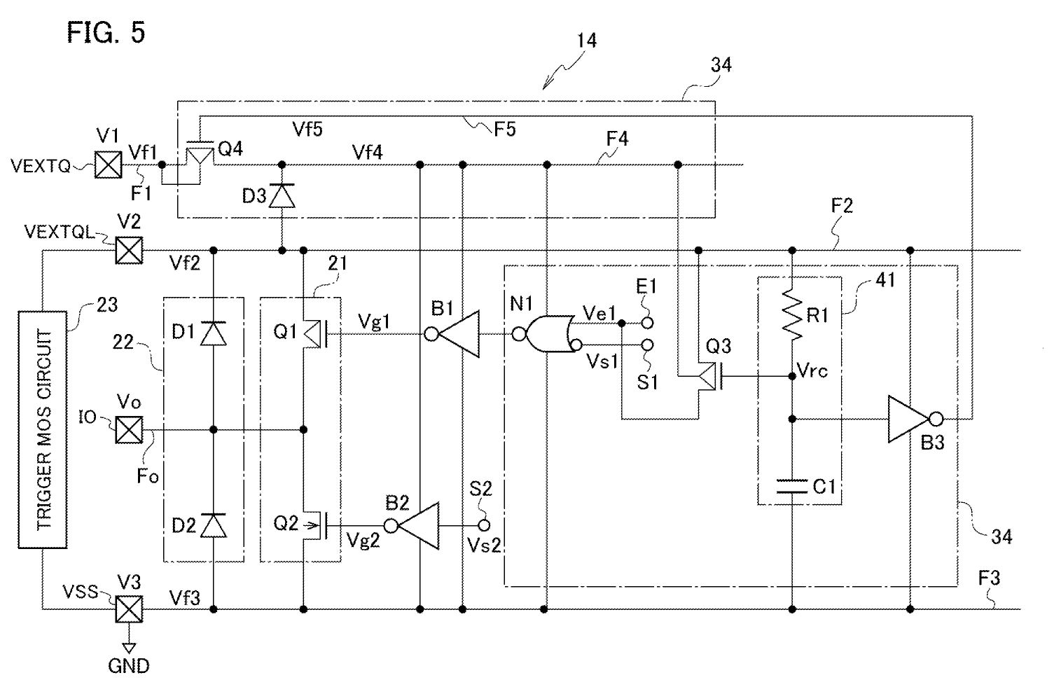

With reference to FIG. 5, a semiconductor device 14 according to a fourth embodiment will be described. FIG. 5 is a circuit diagram illustrating a partial configuration of the semiconductor device 14 according to the fourth embodiment. The semiconductor device 14 according to the fourth embodiment is configured by adding a protection circuit 34 to the semiconductor device 10 according to the reference example.

The protection circuit 34 includes the RC circuit 41, the third transistor Q3, the fourth transistor Q4, a two-input NOR gate N1 with an inverting function added to one input, the third inverter B3, a third diode D3, a fourth line F4, and a fifth line F5. The RC circuit 41 is a series circuit of the resistor R1 and the capacitor C1. The first end of the resistor R1 is connected to the second line F2, the second end of the resistor R1 is connected to the first end of the capacitor C1, and the second end of the capacitor C1 is connected to the third line F3. An input terminal of the third inverter B3 is connected to the connection point between the resistor R1 and the capacitor C1. A positive power terminal of the third inverter B3 is connected to the second line F2, and a negative power terminal is connected to the third line F3.

The fourth transistor Q4 is a semiconductor switch and is configured as a P-channel MOSFET. In the fourth transistor Q4, a gate is connected to the output terminal of the third inverter B3 through the fifth line F5, a source and a body are connected to the first line F1, and a drain is connected to the fourth line F4. The third diode D3 is a semiconductor switch in which the anode is connected to the second line F2, and the cathode is connected to the fourth line F4.

In the fourth embodiment, the positive power terminals of the first inverter B1 and the second inverter B2 are connected to the fourth line F4. The input terminal of the first inverter B1 is connected to the output terminal of the NOR gate N1. In the NOR gate N1, a positive power supply terminal is connected to the fourth line F4 and a negative power supply terminal is connected to the third line F3. The first input terminal of the NOR gate N1 is connected to the first internal terminal S1, and a signal obtained by inverting the first internal signal Vs1 is applied therefrom. The second input terminal of the NOR gate N1 is connected to a first enable terminal E1, and the first internal signal Vs1 is enabled when a first enable signal Ve1 is at the L level, and the first internal signal Vs1 is disabled when the first enable signal Ve1 is at the H level.

The reason why the NOR gate N1 is used is that there is a plurality of sets of first transistors Q1 and first inverters B1 in an actual configuration of the semiconductor device 14, and they are collectively controlled to be enabled or disabled by the first enable signal Ve1.

The third transistor Q3 is a semiconductor switch and is configured as a P-channel MOSFET. In the third transistor Q3, a gate is connected to the connection point between the resistor R1 and the capacitor C1; a source is connected to the second line F2; a body is connected to the fourth line F4; and a drain is connected to the connection point between the second input terminal of the NOR gate N1 and the first enable terminal E1.

The protection circuit 34 does not operate and does not affect the operation of the semiconductor device 14 during normal operation when a discharge such as ESD does not occur at the input/output terminal IO. That is, the potential Vrc at the connection point between the resistor R1 and the capacitor C1 is at the H level of the second potential V2, and the fifth line potential Vf5, which is the output signal of the third inverter B3, is at the L level of the third potential V3. At this point, the fourth transistor Q4 is turned on, so that the first line F1 and the fourth line F4 are connected. Therefore, the fourth line potential Vf4, which is the potential of the fourth line F4, is equal to the first line potential Vf1, that is, the first potential V1. The anode is at the second potential V2 and the cathode is at the first potential V1, so that the third diode D3 is turned off.

The potential Vrc at the connection point between the resistor R1, which is the gate signal, and the capacitor C1 is at the H level of the second potential V2, so that the third transistor Q3 is turned off. Therefore, when the first enable signal Ve1 from the first enable terminal E1 is at the L level, the first internal signal Vs1 is enabled. That is, when the first internal signal Vs1 is at the H level, the first gate signal Vg1 is at the L level of the third potential V3, and when the first internal signal Vs1 is at the L level, the first gate signal Vg1 is at the H level of the first potential V1. When the first enable signal Ve1 from the first enable terminal E1 is at the H level, the first internal signal Vs1 is disabled. That is, regardless of whether the first internal signal Vs1 is at the H level or the L level, the first gate signal Vg1 is at the H level of the first potential V1.

However, when a discharge such as ESD occurs at the input/output terminal IO, the RC circuit 41 of the protection circuit 34 detects a surge caused by the discharge, and the potential Vrc at the connection point between the resistor R1 and the capacitor C1 is switched from the H level to the L level using the second line potential Vf2 as a reference, as described with reference to FIG. 2.

When the potential Vrc at the connection point between the resistor R1 and the capacitor C1 is switched from the H level to the L level, the fifth line potential Vf5, which is the output signal of the third inverter B3, is switched from the L level of the third potential V3 to the H level of the second line potential Vf2. Then, the fourth transistor Q4 is switched from on to off, the first line F1 and the fourth line F4 are disconnected, the third diode D3 is turned on, and the fourth line potential Vf4 of the fourth line F4 is switched from the first potential V1 to the second line potential Vf2. Therefore, the potentials of the positive power terminals of the first inverter B1, the second inverter B2, and the NOR gate N1 switch from the first potential V1 to the second line potential Vf2.

Note that the fourth transistor Q4 is a switch that is provided to prevent a delay in the switching of the fourth line potential Vf4 of the fourth line F4 from the first potential V1 to the second line potential Vf2 when the capacitance of an element connected to the first line F1 is large. Therefore, when the capacitance of the element connected to the first line F1 is sufficiently small, the first line F1 and the fourth line F4 may be directly connected without the fourth transistor Q4.

When the potential Vrc at the connection point between the resistor R1 and the capacitor C1 is switched from the H level to the L level, the third transistor Q3 is switched from off to on, the first enable signal Ve1 is at the H level of the second line potential Vf2, and the first internal signal Vs1 is disabled. The third transistor Q3 and the NOR gate N1 are connected to the first inverter B, thereby configuring a control switch that disables the first internal signal Vs1 when the RC circuit 41 detects a discharge. Then, regardless of whether the first internal signal Vs1 is at the H level or the L level, the first gate signal Vg1 is fixed at the second line potential Vf2 to reduce fluctuations.

Thus, when a discharge such as ESD occurs at the input/output terminal IO, the protection circuit 34 fixes the first gate signal Vg1 at the second line potential Vf2 to reduce fluctuations. Therefore, it is possible to reduce fluctuations of the first gate signal Vg1 even when a discharge such as ESD occurs at the input/output terminal IO. As a result, overvoltage breakdown of the first transistor Q1due to fluctuations of the first gate signal Vg1 can be prevented.

### Fifth Embodiment

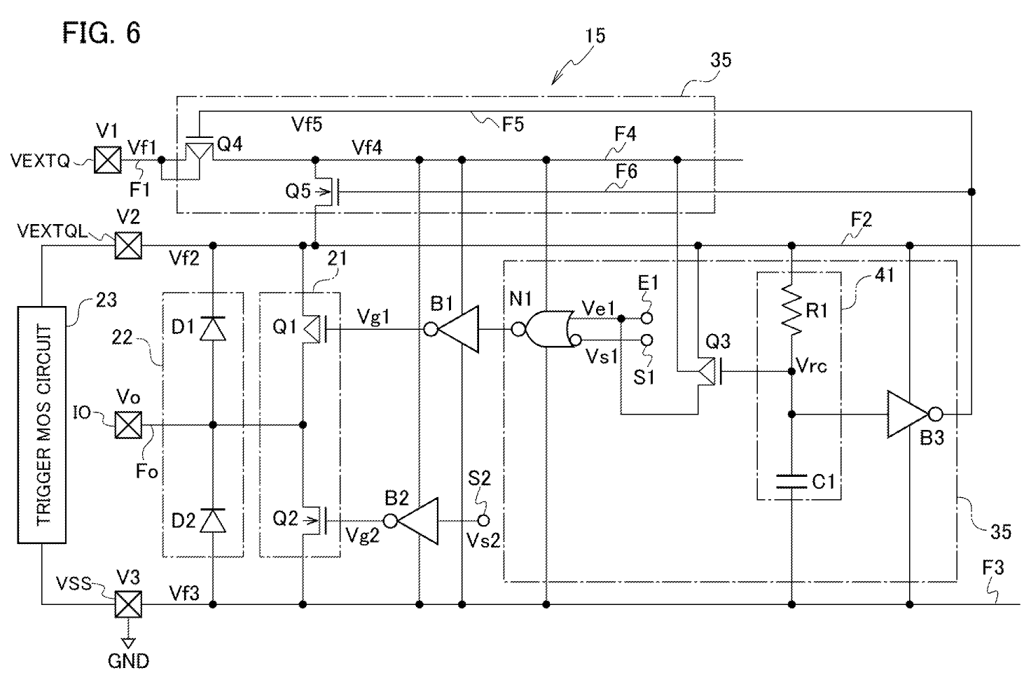

With reference to FIG. 6, a semiconductor device 15 according to a fifth embodiment will be described. FIG. 6 is a circuit diagram illustrating a partial configuration of the semiconductor device 15 according to the fifth embodiment. The semiconductor device 15 according to the fifth embodiment is configured by adding a protection circuit 35 to the semiconductor device 10 according to the reference example.

The protection circuit 35 according to the fifth embodiment differs from the protection circuit 34 according to the fourth embodiment only in that the third diode D3 as a semiconductor switch is replaced with a fifth transistor Q5. The fifth transistor Q5 is configured as an N-channel MOSFET. In the fifth transistor Q5, a drain is connected to the fourth line F4; a source is connected to the second line F2; and a gate is connected to the fifth line F5 through the sixth line F6.

A detailed description of the protection circuit 35 according to the fifth embodiment, which operates in the same manner as the protection circuit 34 according to the fourth embodiment, is not provided.

When a discharge such as ESD occurs at the input/output terminal IO, the protection circuit 35 fixes the first gate signal Vg1 at the second line potential Vf2 to reduce fluctuations. Therefore, it is possible to reduce fluctuations of the first gate signal Vg1 even when a discharge such as ESD occurs at the input/output terminal IO. As a result, overvoltage breakdown of the first transistor Q1due to fluctuations of the first gate signal Vg1 can be prevented.

### Sixth Embodiment

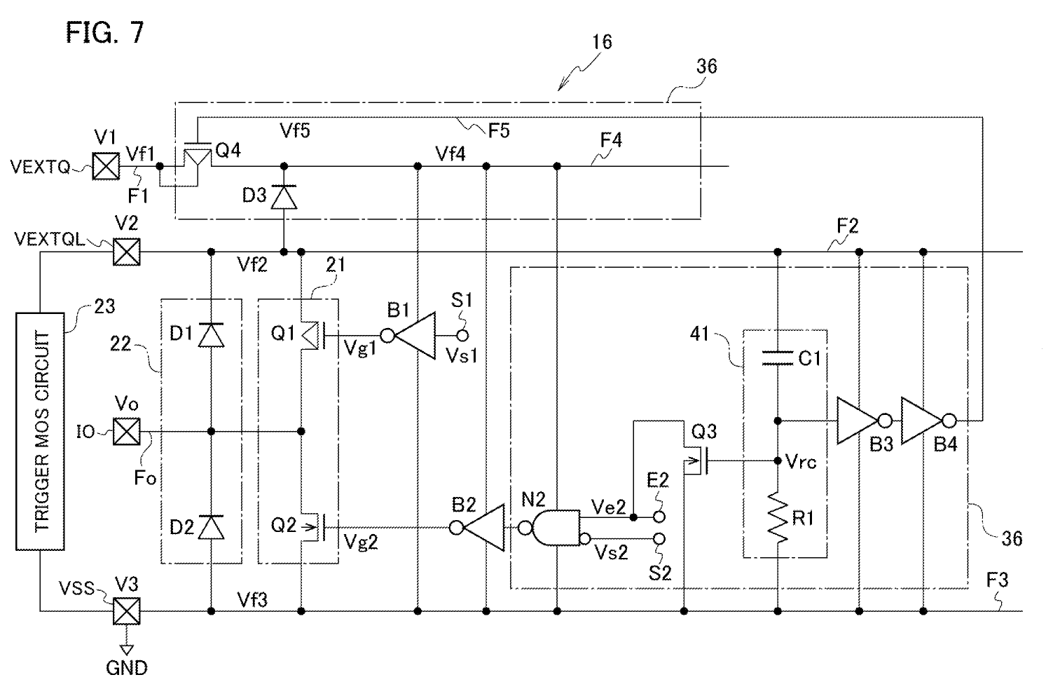

With reference to FIG. 7, a semiconductor device 16 according to the sixth embodiment will be described. FIG. 7 is a circuit diagram illustrating a partial configuration of the semiconductor device 16 according to the sixth embodiment. The semiconductor device 16 according to the sixth embodiment is configured by adding a protection circuit 36 to the semiconductor device 10 according to the reference example.

The protection circuit 36 includes the RC circuit 41, the third transistor Q3, the fourth transistor Q4, a two-input NAND gate N2 with an inverting function added to one input, the third inverter B3, the fourth inverter B4, the third diode D3, the fourth line F4, and the fifth line F5. The RC circuit 41 is a series circuit of the capacitor C1 and the resistor R1, in which the first end of the capacitor C1 is connected to the second line F2, the second end of the capacitor C1 is connected to the first end of the resistor R1, and the second end of the resistor R1 is connected to the third line F3. The input terminal of the third inverter B3 is connected to the connection point between the capacitor C1 and the resistor R1. The input terminal of the fourth inverter B4 is connected to the output terminal of the third inverter B3. The positive power terminals of the third inverter B3 and the fourth inverter B4 are connected to the second line F2, and the negative power terminals of the third inverter B3 and the fourth inverter B4 are connected to the third line F3.

The fourth transistor Q4 is a semiconductor switch and is configured as a P-channel MOSFET. In the fourth transistor Q4, a gate is connected to the output terminal of the fourth inverter B4 through the fifth line F5; a source and a body are connected to the first line F1; and a drain is connected to the fourth line F4. The third diode D3 is a semiconductor switch in which the anode is connected to the second line F2, and the cathode is connected to the fourth line F4.

In the sixth embodiment, the positive power terminals of the first inverter B1 and the second inverter B2 are connected to the fourth line F4. The input terminal of the second inverter B2 is connected to the output terminal of the NAND gate N2. In the NAND gate N2, the positive power terminal is connected to the fourth line F4, and the negative power terminal is connected to the third line F3. The first input terminal of the NAND gate N2 is connected to the second internal terminal S2, and a signal obtained by inverting the second internal signal Vs2 is applied therefrom. The second input terminal of the NAND gate N2 is connected to the second enable terminal E2, and is configured so that the second internal signal Vs2 is enabled when the second enable signal Ve2 is at the H level, and the second internal signal Vs2 is disabled when the second enable signal Ve2 is at the L level.

The reason why the NAND gate N2 is used is that there is a plurality of sets of the second transistors Q2 and the second inverters B2 in an actual configuration of the semiconductor device 16, and they are collectively controlled to be enabled or disabled by the second enable signal Ve2.

The third transistor Q3 is a semiconductor switch and configured as an N-channel MOSFET. In the third transistor Q3, a gate is connected to the connection point between the capacitor C1 and the resistor R1; a drain is connected to the connection point between the second input terminal and the second enable terminal E2 of the NAND gate N2; and a source is connected to the third line F3.

The protection circuit 36 does not operate and does not affect the operation of the semiconductor device 16 during normal operation when a discharge such as ESD does not occur at the input/output terminal IO. That is, the potential Vrc at the connection point between the capacitor C1 and the resistor R1 is at the L level of the third potential V3, the output signal of the third inverter B3 is at the H level of the second potential V2, and the fifth line potential Vf5, which is the output signal of the fourth inverter B4, is at the L level of the third potential V3. At this point, the fourth transistor Q4 is turned on, so that the first line F1 and the fourth line F4 are connected. Therefore, the fourth line potential Vf4, which is the potential of the fourth line F4, is equal to the first line potential Vf1, that is, the first potential V1. The anode is at the second potential V2 and the cathode is at the first potential V1, so that the third diode D3 is turned off.

Note that the fourth transistor Q4 is a switch that is provided to prevent a delay in the switching of the fourth line potential Vf4 of the fourth line F4 from the first potential V1 to the second line potential Vf2 when the capacitance of an element connected to the first line F1 is large. Therefore, when the capacitance of the element connected to the first line F1 is sufficiently small, the first line F1 and the fourth line F4 may be directly connected without providing the fourth transistor Q4.

The potential Vrc at the connection point between the capacitor C1 and the resistor R1, which is the gate signal, is at the L level of the third potential V3, so that the third transistor Q3 is turned off. Therefore, when the second enable signal Ve2 from the second enable terminal E2 is at the H level, the second internal signal Vs2 is enabled. That is, when the second internal signal Vs2 is at the H level, the second gate signal Vg2 is at the L level of the third potential V3, and when the second internal signal Vs2 is at the L level, the second gate signal Vg2 is at the H level of the first potential V1. When the second enable signal Ve2 from the second enable terminal E2 is at the L level, the second internal signal Vs2 disabled. That is, regardless of whether the second internal signal Vs2 is at the H level or the L level, the second gate signal Vg2 is at the L level of the third potential V3.

However, when a discharge such as ESD occurs at the input/output terminal IO, the RC circuit 41 of the protection circuit 36 detects a surge caused by the discharge, and the potential Vrc at the connection point between the capacitor C1 and the resistor R1 is switched from the L level of the third potential V3 to the H level using the second line potential Vf2 as a reference.

When the potential Vrc at the connection point between the capacitor C1 and the resistor R1 is switched from the L level to the H level, the fifth line potential Vf5, which is the output signal of the fourth inverter B4, is switched from the L level of the third potential V3 to the H level of the second line potential Vf2. Then, the fourth transistor Q4 is switched from on to off, the first line F1 and the fourth line F4 are disconnected, the third diode D3 is turned on, and the fourth line potential Vf4 of the fourth line F4 is switched from the first potential V1 to the second line potential Vf2. Therefore, the potentials of the positive power terminals of the first inverter B1, the second inverter B2, and the NAND gate N2 are switched from the first potential V1 to the second line potential Vf2.

When the potential Vrc at the connection point between the capacitor C1 and the resistor R1 is switched from the L level to the H level, the third transistor Q3 is switched from off to on, the second enable signal Ve2 is at the L level of the third potential V3, and the second internal signal Vs2 is disabled. The third transistor Q3 and the NAND gate N2 are connected to the input terminal of the second inverter B2, thereby configuring a control switch that disables the second internal signal Vs2 when the RC circuit 41 detects a discharge. Then, regardless of whether the second internal signal Vs2 is at the H level or the L level, the second gate signal Vg2 is fixed at the third potential V3 to reduce fluctuations.

Thus, the protection circuit 36 fixes the second gate signal Vg2 at the third potential V3 to reduce fluctuations when a discharge such as ESD occurs at the input/output terminal IO. Therefore, it is possible to reduce fluctuations of the second gate signal Vg2 even when a discharge such as ESD occurs at the input/output terminal IO. As a result, overvoltage breakdown of the second transistor Q2 due to fluctuations of the second gate signal Vg2 can be prevented.

### Seventh Embodiment

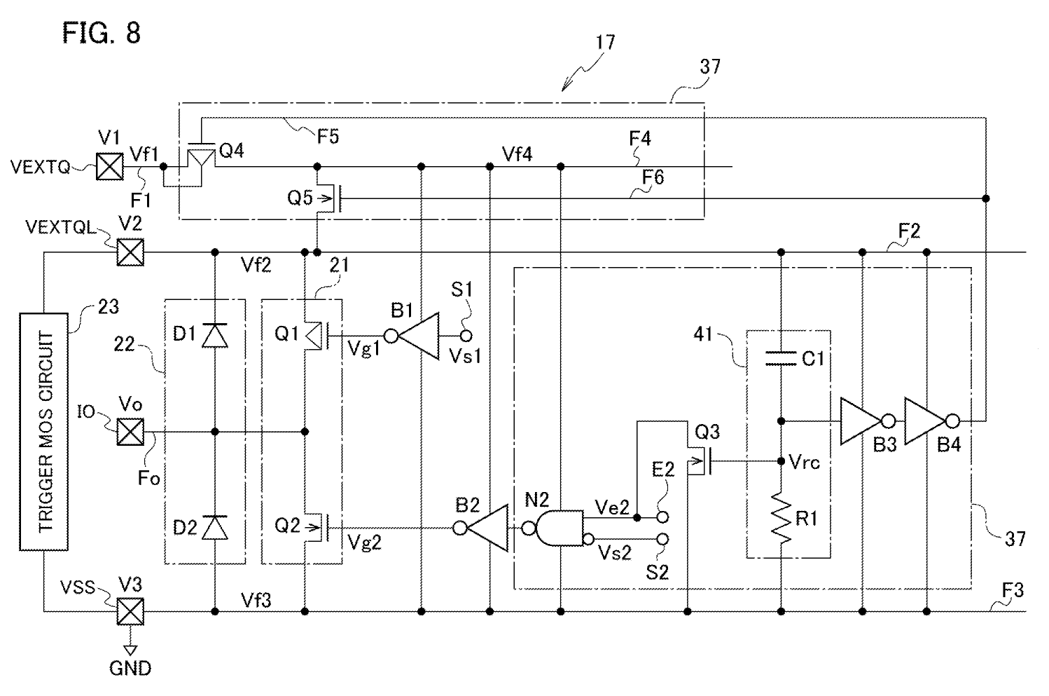

With reference to FIG. 8, a semiconductor device 17 according to a seventh embodiment will be described. FIG. 8 is a circuit diagram illustrating a partial configuration of the semiconductor device 17 according to the seventh embodiment. The semiconductor device 17 according to the seventh embodiment is configured by adding a protection circuit 37 to the semiconductor device 10 according to the reference example.

The protection circuit 37 according to the seventh embodiment differs from the protection circuit 36 according to the sixth embodiment only in that the third diode D3 as a semiconductor switch is replaced with the fifth transistor Q5. The fifth transistor Q5 is configured as an N-channel type MOSFET. In the fifth transistor Q5, a drain is connected to the fourth line F4; a source is connected to the second line F2; and a gate is connected to the fifth line F5 through a sixth line F6.

A detailed description if the protection circuit 37 according to the seventh embodiment, which operates in the same manner as the protection circuit 36 according to the sixth embodiment, is not provided.

The protection circuit 37 fixes the second gate signal Vg2 at the third potential V3 to reduce fluctuations when a discharge such as ESD occurs at the input/output terminal IO. Therefore, it is possible to reduce fluctuations of the second gate signal Vg2 even when a discharge such as ESD occurs at the input/output terminal IO. As a result, overvoltage breakdown of the second transistor Q2 due to fluctuations of the second gate signal Vg2 can be prevented.

The protection circuit 31, the protection circuit 34, or the protection circuit 35 capable of protecting the first transistor Q1; and the protection circuit 32, the protection circuit 33, the protection circuit 36, or the protection circuit 37 capable of protecting the second transistor Q2, can be combined, as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A semiconductor device, comprising:
a first line to which a first potential is applied during normal operation, the first line having a first line potential;
a second line to which a second potential lower than the first potential is applied during normal operation, the second line having a second line potential;
a third line to which a third potential lower than the second potential is applied;
a switch circuit which is connected between the second line and the third line and is a series circuit of a first transistor on a side of the second line and a second transistor on a side of the third line;
an input/output terminal connected to a connection point between the first transistor and the second transistor;
a first prebuffer in which a positive power terminal is connected to the first line, a negative power terminal is connected to the third line, and an output terminal is connected to a control electrode of the first transistor;
a second prebuffer in which a positive power terminal is connected to the first line, a negative power terminal is connected to the third line, and an output terminal is connected to a control electrode of the second transistor; and
a protection circuit configured to control a potential of the control electrode of at least one of the first transistor and the second transistor to be greater than or equal to the third potential, and less than or equal to the second line potential, when a discharge from the input/output terminal is detected.

2. The semiconductor device according to claim 1, further comprising:
a first diode connected to first and second electrodes of the first transistor in parallel with the first transistor, and a second diode connected to first and second electrodes of the second transistor in parallel with the second transistor, wherein
the first transistor is configured as a P-channel MOSFET, and
the second transistor is configured as an N-channel MOSFET.

3. The semiconductor device according to claim 2, wherein
the protection circuit comprises an RC circuit which is a series circuit of a first resistor and a capacitor, and which is connected between the second line and the third line, and
the protection circuit is configured to control the potential of at least one of the control electrode of the first transistor and the control electrode of the second transistor to be greater than or equal to the third potential, and less than or equal to the second line potential, when the RC circuit detects the discharge from the input/output terminal.

4. The semiconductor device according to claim 3, wherein
the protection circuit further comprises a third transistor configured as a P-channel MOSFET,
a terminal of the first resistor is connected to the second line, and a terminal of the capacitor is connected to the third line,
a control electrode of the third transistor is connected to a connection point between the first resistor and the capacitor, a first electrode of the third transistor is connected to the second line, and a second electrode of the third transistor is connected to the control electrode of the first transistor, and
the protection circuit is configured to control the potential of the control electrode of the first transistor to be the second line potential when the RC circuit detects the discharge from the input/output terminal.

5. The semiconductor device according to claim 3, wherein
the protection circuit further comprises a third transistor configured as an N-channel MOSFET and a second resistor,
a terminal of the capacitor is connected to the second line, and a terminal of the first resistor is connected to the third line,
a control electrode of the third transistor is connected to a connection point between the capacitor and the first resistor, a second electrode of the third transistor is connected to the control electrode of the second transistor, and a first electrode of the third transistor is connected to the third line through the second resistor, and
the protection circuit is configured to control the potential of the control electrode of the second transistor to be greater than or equal to the third potential, and less than or equal to the second line potential, when the RC circuit detects the discharge from the input/output terminal.

6. The semiconductor device according to claim 5, wherein the protection circuit is configured to control the potential of the control electrode of the second transistor to be greater than or equal to the second line potential, and less than or equal to the third potential, by using a potential generated in the second resistor by at least one of a displacement current and a gate leak current of the second transistor.

7. The semiconductor device according to claim 3, wherein
the protection circuit further comprises a voltage divider circuit which is a series circuit of a first voltage divider resistor and a second voltage divider resistor, a first semiconductor switch, and a second semiconductor switch,
a first terminal of the voltage divider circuit is connected to the second line through the first semiconductor switch, and a second terminal of the voltage divider circuit is connected to the third line,
a connection point between the first voltage divider resistor and the second voltage divider resistor is connected to the control electrode of the second transistor through the second semiconductor switch, and
the protection circuit is configured to control the first semiconductor switch and the second semiconductor switch to be turned off when the RC circuit does not detect the discharge from the input/output terminal, and controls the first semiconductor switch and the second semiconductor switch to be turned on when the RC circuit detects the discharge from the input/output terminal.

8. The semiconductor device according to claim 2, wherein the first diode is a parasitic diode of the first transistor, and the second diode is a parasitic diode of the second transistor.

9. A semiconductor device, comprising:
a first line to which a first potential is applied during normal operation, the first line having a first line potential;
a second line to which a second potential lower than the first potential is applied during normal operation;
a third line to which a third potential lower than the second potential is applied;
a first semiconductor switch;
a fourth line connected to the first line through the first semiconductor switch;
a second semiconductor switch connecting the second line and the fourth line;
a switch circuit which connects the second line and the third line and is a series circuit of a first transistor on a side of the second line and a second transistor on a side of the third line;
an input/output terminal connected to a connection point between the first transistor and the second transistor;
a first prebuffer in which a positive power terminal is connected to the fourth line, a negative power terminal is connected to the third line, and an output terminal is connected to a control electrode of the first transistor;
a second prebuffer in which a positive power terminal is connected to the fourth line, a negative power terminal is connected to the third line, and an output terminal is connected to a control electrode of the second transistor; and
a protection circuit configured to control the first semiconductor switch to be turned on and the second semiconductor switch to be turned off when a discharge from the input/output terminal is not detected, and control the first semiconductor switch to be turned off and the second semiconductor switch to be turned on when a discharge from the input/output terminal is detected.

10. The semiconductor device according to claim 9, wherein
the protection circuit comprises a control switch which is connected to an input terminal of at least one of the first prebuffer and the second prebuffer, and which is switched to enable or disable an input signal into the input terminal, and
the protection circuit is configured to control the control switch to disable the input signal when a discharge from the input/output terminal is detected.

11. The semiconductor device according to claim 10, further comprising:
a first diode connected to first and second electrodes of the first transistor in parallel with the first transistor, and a second diode connected to first and second electrodes of the second transistor in parallel with the second transistor, wherein
the first transistor is configured as a P-channel MOSFET, and
the second transistor is configured as an N-channel MOSFET.

12. The semiconductor device according to claim 11, wherein
the protection circuit comprises an RC circuit which is a series circuit of a resistor and a capacitor, and which is connected between the second line and the third line, and
the protection circuit is configured to detect the discharge from the input/output terminal by the RC circuit.

13. The semiconductor device according to claim 9, wherein the second semiconductor switch is a diode.

14. The semiconductor device according to claim 9, wherein the second semiconductor switch is a transistor.

15. The semiconductor device according to claim 11, wherein the first diode is a parasitic diode of the first transistor, and the second diode is a parasitic diode of the second transistor.

16. A semiconductor device, comprising:
a first line to which a first potential is applied during normal operation, the first line having a first line potential;
a second line to which a second potential lower than the first potential is applied during normal operation;
a third line to which a third potential lower than the second potential is applied,
a semiconductor switch connecting the second line and the first line;
a switch circuit which is connected between the second line and the third line and is a series circuit of a first transistor on a side of the second line and a second transistor on a side of the third line;
a first prebuffer in which a positive power terminal is connected to the first line, a negative power terminal is connected to the third line, and an output terminal is connected to a control electrode of the first transistor;
a second prebuffer in which a positive power terminal is connected to the first line, a negative power terminal is connected to the third line, and an output terminal is connected to a control electrode of the second transistor; and
a protection circuit configured to control the semiconductor switch to be turned off when a discharge from the input/output terminal is not detected, and control the semiconductor switch to be turned on when a discharge from the input/output terminal is detected.
